(19) United States
(12) Patent Application Publication
(10) Pub. No.: US 2023/0077653 A1
(43) Pub. Date: Mar. 16, 2023

(54) METHOD AND APPARATUS FOR PROVIDING CHART FOR PROJECT SCHEDULE MANAGEMENT

(71) Applicant: KOREA AEROSPACE RESEARCH INSTITUTE, Daejeon (KR)

(72) Inventor: Jae-Hoon SONG, Daejeon (KR)

(21) Appl. No.: 17/940,259

(22) Filed: Sep. 8, 2022

(30) Foreign Application Priority Data
Sep. 14, 2021 (KR) 10-2021-0122463

(51) Int. Cl. G06Q 10/06

(52) U.S. Cl. CPC G06Q 10/063118

(57) ABSTRACT

A method and apparatus for providing a chart for project schedule management are disclosed. The method of providing a chart for project schedule management may include receiving a user input for at least one task schedule from a user, providing, to a user, a chart including a horizontal axis indicating actual time according to a progress of the at least one task schedule and a vertical axis indicating a target date to complete the at least one task schedule, outputting, on the chart, a project mark related to the at least one task schedule, and outputting an on-time baseline in which the actual time coincides with the target date.

### CROSS-REFERENCE TO RELATED APPLICATION

This application claims the benefit of Korean Patent Application No. 10-2021-0122463 filed on Sep. 14, 2021, in the Korean Intellectual Property Office, the entire disclosure of which is incorporated herein by reference for all purposes.

### BACKGROUND

### 1. Field of the Invention

The disclosure relates to a method of providing a chart for project schedule management.

The present disclosure is a project corresponding the project reference number 1711133153 and detailed reference number 2016M1A3A9005561 and a result achieved by the Korea Aerospace Research Institute from Jan. 1, 2021, to Dec. 31, 2021 to support the lunar orbiter and lunar exploration phase 2 prior technology development project of the lunar exploration research and development (R&D) project of the National Research Foundation of Korea. The present disclosure includes a method of providing a chart for project schedule management.

### 2. Description of the Related Art

In the industry developing a large and complicated system through long-term research and development (R&D), such as the aerospace field, schedule management is performed by using various methods in a system engineering aspect. For example, as one of the most popular and intuitive methods, schedule management is performed by using a two-dimensional (2D) plane with the horizontal axis indicating time and the vertical axis indicating a task to be performed, wherein important milestones are marked as separate symbols at a specific date on a Gantt chart showing each task as a bar.

### SUMMARY

According to one embodiment, a method of providing a chart for project schedule management may include receiving a user input for at least one task schedule from a user, providing, to a user, a chart including a horizontal axis indicating actual time according to a progress of the at least one task schedule and a vertical axis indicating a target date to complete the at least one task schedule, outputting, on the chart, a project mark related to the at least one task schedule, and outputting an on-time baseline in which the actual time coincides with the target date.

The outputting of the on-time baseline may include outputting an on-time baseline of which a slope is 1, and the actual time according to the progress of the at least one task schedule coincides with the target date to complete the at least one task schedule.

The method may further include outputting a current time baseline indicating a current time point.

The outputting of the project mark related to the at least one task schedule may include, when the task is completed, marking the project mark with a project mark in a first shape.

The outputting of the project mark related to the at least one task schedule may include, when the task is not completed, marking the project mark with a project mark in a second shape.

The outputting of the project mark related to the at least one task schedule may include, when the actual time according to the progress of the at least one task schedule is the same as the target date to complete the at least one task schedule, marking the project mark on the on-time baseline.

The outputting of the project mark related to the at least one task schedule may include, when the actual time according to the progress of the at least one task schedule is ahead of the target date to complete the at least one task schedule, marking the project mark above the on-time baseline.

The outputting of the project mark related to the at least one task schedule may include, when the actual time according to the progress of the at least one task schedule is behind the target date to complete the at least one task schedule, marking the project mark below the on-time baseline.

The method may further include providing a Gantt chart.

According to one embodiment, an apparatus for providing a chart for project schedule management may include a user input receiver configured to receive a user input for at least one task schedule from a user, a processor configured to generate a chart including a horizontal axis indicating actual time according to a progress of the at least one task schedule and a vertical axis indicating a target date to complete the at least one task schedule, and a display configured to output the generated chart on a screen, wherein the display may output a project mark related to the at least one task schedule on the chart, and output an on-time baseline in which the actual time coincides with the target date on the chart.

The display may output an on-time baseline of which a slope is 1, and the actual time according to the progress of the at least one task schedule may coincide with the target date for completing the at least one task schedule.

The display may output a current time baseline indicating a current time point.

When the task is completed, the display may mark the project mark with a project mark in a first shape.

When the task is not completed, the display may mark the project mark with a project mark in a second shape.

The processor may be configured to, when the actual time according to the progress of the at least one task schedule is the same as the target date to complete the at least one task schedule, mark the project mark on the on-time baseline through the display.

The processor may be configured to, when the actual time according to the progress of the at least one task schedule is ahead of the target date to complete the at least one task schedule, mark the project mark above the on-time baseline through the display.

The processor may be configured to, when the actual time according to the progress of the at least one task schedule is behind the target date to complete the at least one task schedule, mark the project mark below the on-time baseline through the display.

The display may provide a Gantt chart.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIGS. 1A and 1B are diagrams illustrating a T² chart for project schedule management according to an example embodiment;

FIG. 2 is a flowchart illustrating a method of providing a T²-chart, according to an example embodiment;

FIG. 3 is a flowchart illustrating a method of displaying a shape of a project mark in the method of providing a T²-chart, according to an example embodiment;

FIG. 4 is a flowchart illustrating a method of marking a position of a project mark in the method of providing a T²-chart, according to an example embodiment;

FIG. 5 is a detailed example of a T²-chart according to an example embodiment;

FIG. 6 is an example of using a T²-chart with a Gantt chart according to an example embodiment; and

FIG. 7 is a configuration of a drive device of a T²-chart for project schedule management according to an example embodiment.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings. When describing the example embodiments with reference to the accompanying drawings, like reference numerals refer to like constituent elements and a repeated description related thereto will be omitted.

The present disclosure relates to a method and apparatus for providing a T²-chart for project schedule management.

For a predetermined task of a project that requires effective and efficient schedule management, the T²-chart for project schedule management may provide a chart with a new concept that may intuitively observe a progress of schedule adherence or schedule change (delay or shortening) over time.

In a project requiring schedule management, a unit task may be defined by a start date and an end date. In the Gantt chart, degree of task progress may be represented by a progress rate (%). In the proposed T²-chart, degree of task progress may be represented by a slope. The T²-chart may have the horizontal axis indicating an actual time, the vertical axis indicating a target date, and an on-time baseline, which is an extension line having a slope of “1” where the actual time and the target date coincide with each other. For example, when a predetermined task is normally performed, a mark indicating the task may move along the on-time baseline having a slope of “1”. When the current progress of the predetermined task is behind schedule, a project marking point indicating the task may be below the on-time baseline, and when the current progress of the predetermined task is ahead of schedule, the marking point indicating the task may be on the on-time baseline.

The T²-chart may include the horizontal axis indicating time and the vertical axis indicating tasks to be performed on a 2D plane and may interoperate with the Gantt showing all schedules of the total project through dependency between tasks in bar shapes with marks showing the start and the end of the tasks. That is, in case sufficient information of the predetermined task, such as an input manpower and a necessary budget, is provided, a quantitative analysis and prediction for the task progress may be available through slope information at the current time point or a predetermined time point.

A proposed idea is limited to a system engineering perspective, specifically, limited to the aerospace field, and is applied to, for example, major milestone conferences, such as a system design review (SDR), a preliminary design review (PDR), and a critical design review (CDR). However, the example is not limited to the major milestone conference of the aerospace field in the system engineering perspective and may be applied to schedule management of a typical project.

Hereinafter, a detailed description of the method and apparatus for providing a chart is provided with reference to the drawings.

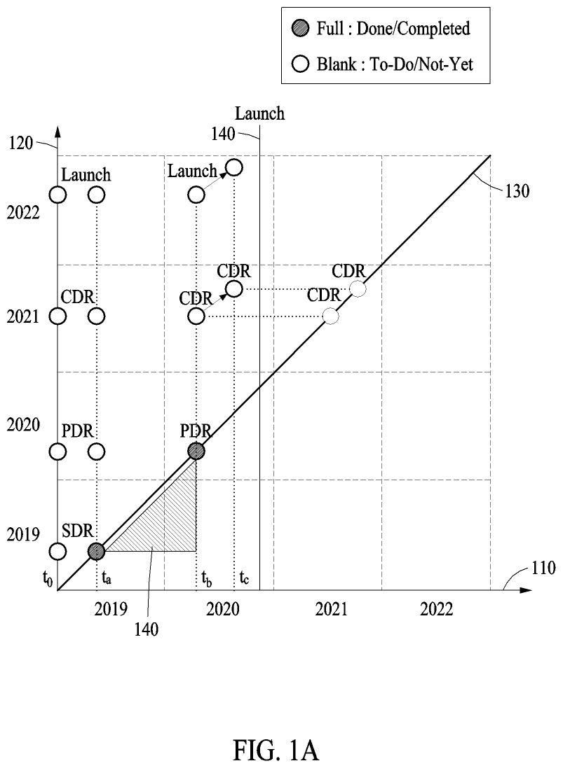

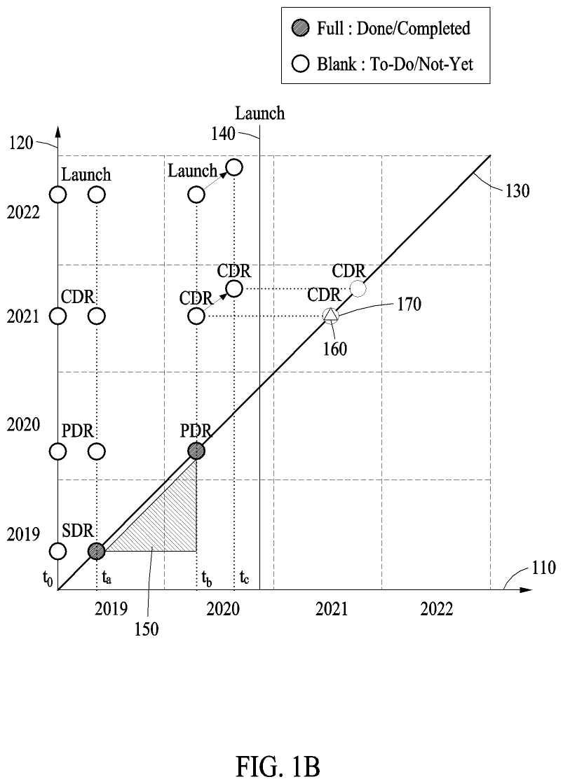

FIGS. 1A and 1B are diagrams illustrating a T²-chart for project schedule management.

Referring to FIG. 1A, the T²-chart may be based on the horizontal axis and the vertical axis perpendicular to each other on a 2D plane. A point where a horizontal axis 110 meets a vertical axis 120 may be an origin and may represent a starting point of a project. The horizontal axis 110 may represent an actual time and may be an axis indicating the actual time that elapsed as the project progresses. The vertical axis 120 may represent a target date planned for a predetermined task desired to be managed or a milestone. An on-time baseline 130 may be a diagonal line of which a slope dividing the horizontal axis and the vertical axis into two is “1”. A current time axis 140 may be an axis indicating a current time point. An actual period based on a project plan may be shown on a 2D plane. As shown in FIG. 1A, for example, based on the given project plan, when there is a plan for an SDR in March 2019, a PDR in February 2020, a CDR in June 2021, and the launch in July 2022, the estimated time of the planned milestones may be marked along the vertical axis 120 from an origin to. To mark a predetermined task or a milestone in the T²-chart, those already completed may be marked with a black dot and those to be performed in the future or not yet completed may be marked with a white dot. Accordingly, at the origin, that is, at t₀ at the time of January 2019, all planned milestones may be marked with white dots along the vertical axis 120. When a project period has elapsed and the SDR has completed in March 2019 tₐ as all personnel performed the project according to the schedule, the SDR may be marked with a black dot along the tₐ time point in the vertical axis from the horizontal axis 110 indicating the actual time and the PDR, CDR, and the launch may be marked with white dots unchanged from the project starting point. When the PDR has completed in February 2020 t_{b} as all personnel performed the project according to the schedule after the SDR, the PDR may be marked with a black dot at the time point February 2020 t_{b}. The area of a right triangle 150 between March 2019 tₐ and February 2020 t_{b} may represent the amount of effort by the project participants. It is supposed that the CDR has changed from June 2021 to September 2021 and the launch has changed from July 2022 to October 2022 because an unexpected defect or error has occurred in July 2020 t_{c} and all schedule is expected to be delayed as a result of analyzing schedule impact by the unexpected defect or error. However, in case the initial launch time, July 2022, needs to be committed because the three-month delay is not acceptable, the slope of the diagonal line of the right triangle 150 may need to be greater than or equal to 1 through various schedule optimization, such as providing additional resources. The T²-chart may be utilized for project schedule management by increasing a change rate of the vertical axis 120 indicating the target date is greater than the passage of time in the horizontal axis 110.

Referring to FIG. 1B, an example of a T²-chart according to another example embodiment is shown. A shape illustrating a project schedule 160 having the same schedule as a CDR project schedule 170 on the on-time baseline 130 in the T²-chart may be the same as FIG. 1B. Although the CDR project schedule 170 having the same schedule as the project schedule 160 on the on-time baseline 130 is illustrated as a circle and the project schedule 160 is illustrated as a triangle, the example is not limited thereto.

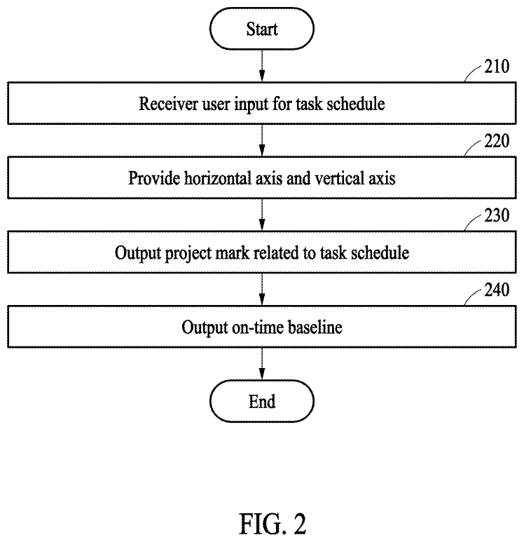

FIG. 2 is a flowchart illustrating a method of providing a T²-chart.

Referring to FIG. 2, in operation 210, a drive device may receive a user input for a project schedule. The user may set a target date to an expected completion time of the project.

In operation 220, the drive device may provide, to the user, the horizontal axis indicating actual elapsed time and the vertical axis indicating a target date of project completion.

In operation 230, the drive device may output a project mark related to the project schedule

In operation 240, the drive device may output an on-time baseline. The on-time baseline may be a reference line having a slope of 1 that the actual elapsed time as the project schedule progresses coincides with the target date when the project schedule is completed.

In one embodiment, the drive device may further output a current time baseline indicating the current time point.

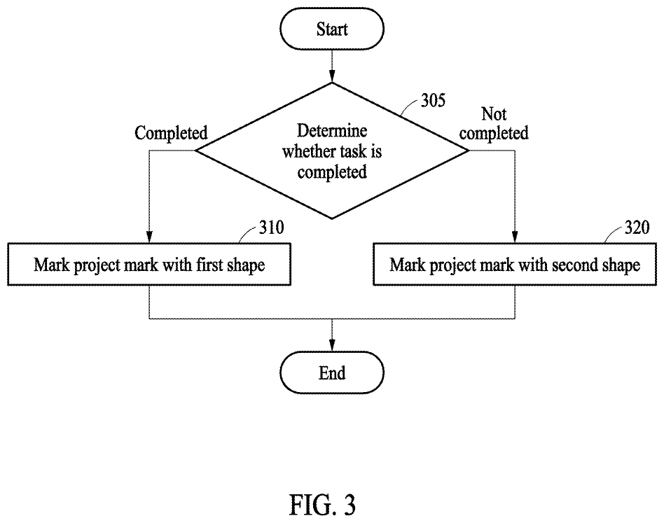

FIG. 3 is a flowchart illustrating a method of displaying a shape of a project mark in the method of providing a T²-chart, according to an example embodiment.

Referring to FIG. 3, in operation 305, a drive device may determine whether a task has been completed according to the project schedule. When the task has been completed, in operation 310, the drive device may mark a project mark with a first shape. When the task is not completed, in operation 320, the drive device may mark the project mark with a second shape. For example, the drive device may mark a completed task with a black dot and an uncompleted task with a white dot to distinguish between the completed task and the uncompleted task.

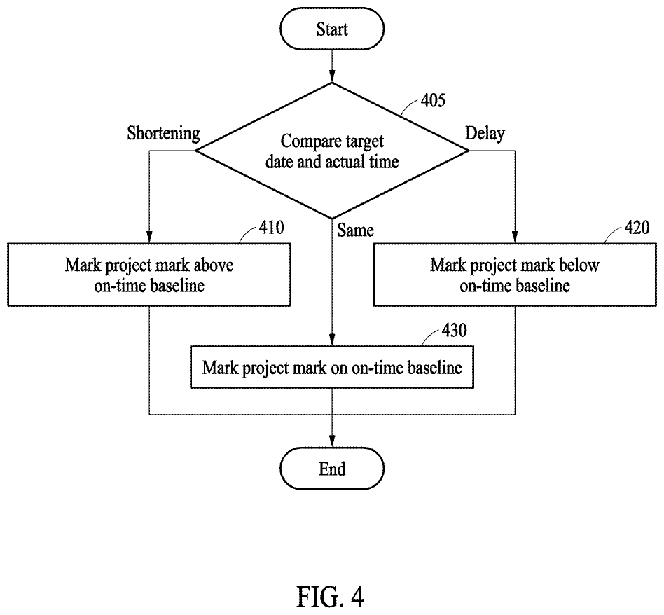

FIG. 4 is a flowchart illustrating a method of marking a position of a project mark in the method of providing a T²-chart, according to an example embodiment.

Referring to FIG. 4, in operation 405, the drive device may compare the actual time to the project target date according to the project schedule. When the actual time is shorter than the project target date, in operation 410, the drive device may mark a project mark above the on-time baseline. When the actual time is behind the project target date, in operation 420, the drive device may mark the project mark below the on-time baseline. When the actual time is the same as the project target date, in operation 430, the drive device may mark the project mark on the on-time baseline.

The user may identify detailed information about the project including information on a project manager, manpower input to the project, a cost related to the project, and a location of the project by selecting the mark of the drive device.

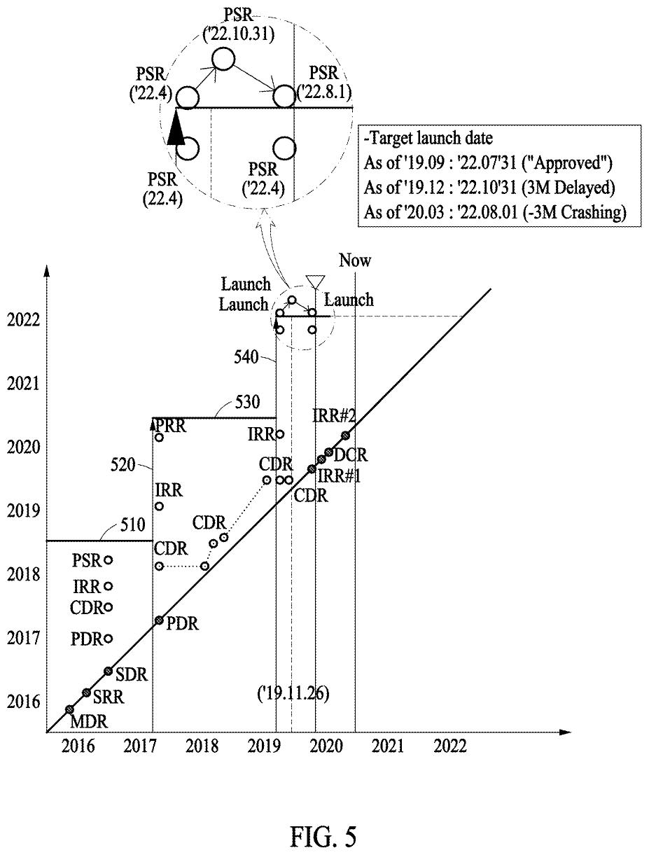

FIG. 5 is a detailed example of a T²-chart according to an example embodiment.

An initial goal of a lunar exploration project was to “develop a trial lunar orbiter of a 550 kg level based on international cooperation and launch by using a foreign launch vehicle”, and the project period was 3 years from January 2016 to December 2018, as shown in a section 510 of the T²-chart. However, due to a first project plan modification in August 2017, the project period changed from 3 years to 5 years as shown in a section 520 of the T²-chart. Thereafter, as shown in a section 530 of the T²-chart, the project period proceeded without change, and then in September 2019, through a second project plan modification, the project plan extended from 5 years to 6 years and 7 months as shown in a section 540 of the T²-chart. After a change in a project performance system, based on September 2020, the launch was aimed at Aug. 1, 2022. According to the first project plan modification, a Korea Pathfinder Lunar Orbiter (KPLO) CDR was planned to be completed in September 2018. However, as shown in the T²-chart of FIG. 5, the plan was not normally performed. According to the third project plan modification in March 2020 after the project performance system change, based on September 2020, the project was performed as planned.

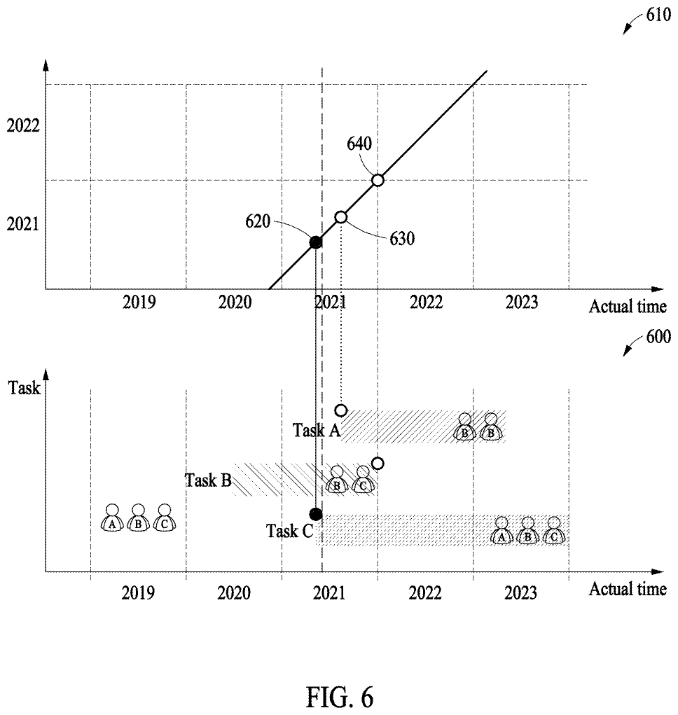

FIG. 6 is an example of using a T²-chart with a Gantt chart according to an example embodiment. A Gantt chart 600 may be a bar chart for project schedule management and may be commonly used. Through this, the overall schedule may be viewed at a glance by identifying a main task of the project and marking a starting point and an end point of each task in a connected bar shape. A project mark 620 in a T²-chart 610 may represent a start date of a project performed by A, B, and C, shown as Task C in the Gantt chart. A project mark 630 may represent a start date of a project shown as Task A and performed by B and a project mark 640 may represent an end date of a project shown as Task B and performed by B and C. As described above, a start date and an end date of a task shown on the Gantt chart 600 may be reflected in the T²-chart 610. Since both the T²-chart 610 and the Gantt chart 600 include the horizontal axis indicating the actual time, interoperation may be available as shown in FIG. 6.

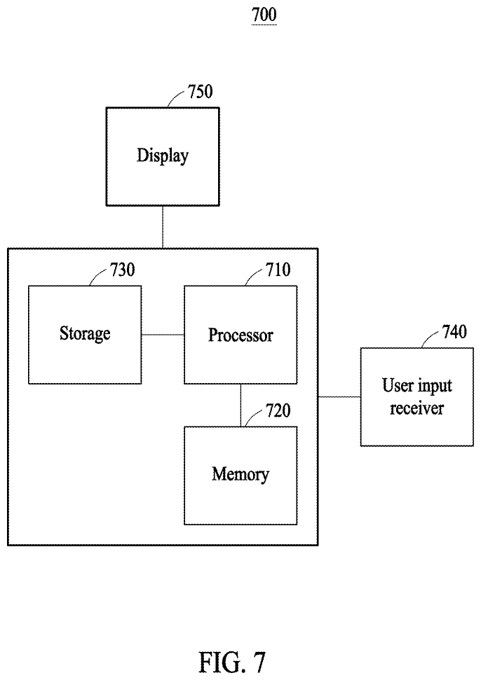

FIG. 7 is a configuration of a drive device 700 of a T²-chart for project schedule management.

Referring to FIG. 7, the drive device 700 of the T²-chart for project schedule management may include a processor 710, a memory 720, a storage 730, a user input receiver 740, and a display 750. The drive device 700 of the T²-chart for project schedule management may correspond to the method of providing a T²-chart for project schedule management described with reference to FIGS. 1 to 6, and the drive device 700 of the T²-chart for project schedule management may be a user terminal in which an application or a website related to the method of providing a T²-chart for project schedule management is installed or executed.

The memory 720 may be connected to the processor 710 and may store instructions executable by the processor 710, data to be computed by the processor 710, or data processed by the processor 710. The memory 720 may include a non-transitory computer-readable medium, for example, high-speed random-access memory (RAM), and/or a nonvolatile computer-readable storage medium (e.g., one or more disk storage devices, flash memory devices, or other nonvolatile solid state memory devices).

The storage 730 may store a user input for at least one task schedule based on the user input.

The display 750 may display a screen of an application or a web related to the method of providing a T²-chart for project schedule management.

The user input receiver 740 may receive a user input, input by the user, for at least one task schedule. For example, the user input receiver 740 may be a touch screen, a physical button, and a microphone.

The processor 710 may control the drive device 700 of the T²-chart for project schedule management to perform one or more operations related to the operations of the drive device 700 of the T²-chart for project schedule management described in this disclosure. For example, the processor 710 may control the drive device 700 of the T²-chart for project schedule management to receive a user input for at least one task schedule from a user, and provide, to a user, a chart including the horizontal axis indicating actual time according to a progress of the at least one task schedule and the vertical axis indicating a target date to complete the at least one task schedule.

For example, the processor 710 may control the drive device 700 of the T²-chart for project schedule management to output a project mark related to the at least one task schedule on the chart and output an on-time baseline in which the actual time coincides with the target date.

For example, the processor 710 may control the drive device 700 of the T²-chart for project schedule management to output an on-time baseline of which a slope is 1, and the actual time according to the progress of the task schedule coincides with the target date to complete the at least one task schedule.

For example, when providing the T²-chart for project schedule management, the processor 710 may control the drive device 700 of the T²-chart for project schedule management to further output a current time baseline indicating a current time point.

For example, when the drive device 700 outputs the project mark related to the at least one task schedule and the task is completed, the processor 710 may control the drive device 700 of the T2—chart for project schedule management to mark the project mark with a project mark in a first shape.

For example, when the drive device outputs the project mark related to the at least one task schedule and the task is not completed, the processor 710 may control the drive device 700 of the T2—chart for project schedule management to mark the project mark with a project mark in a second shape.

For example, when the drive device 700 outputs the project mark related to the at least one task schedule and the actual time according to the progress of the at least one task schedule is the same as the target date to complete the at least one task schedule, the processor 710 may control the drive device 700 of the T2—chart for project schedule management to mark the project mark on the on-time baseline.

For example, when the drive device 700 outputs the project mark related to the at least one task schedule and the actual time according to the progress of the at least one task schedule is ahead of the target date to complete the at least one task schedule, the processor 710 may control the drive device 700 of the T2—chart for project schedule management to mark the project mark above the on-time baseline.

For example, when the drive device 700 outputs the project mark related to the at least one task schedule and the actual time according to the progress of the at least one task schedule is behind the target date to complete the at least one task schedule, the processor 710 may control the drive device 700 of the T²-chart for project schedule management to mark the project mark below the on-time baseline.

For example, when providing the T²-chart for project schedule management, the processor 710 may control the drive device 700 of the T²-chart for project schedule management to further provide a Gantt chart.

The examples described herein may be implemented using hardware components, software components and/or combinations thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical equipment or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of providing a chart for project schedule management, the method comprising:
receiving a user input for at least one task schedule from a user;
providing, to a user, a chart comprising a horizontal axis indicating actual time according to a progress of the at least one task schedule and a vertical axis indicating a target date to complete the at least one task schedule;
outputting, on the chart, a project mark related to the at least one task schedule; and
outputting an on-time baseline in which the actual time coincides with the target date.

2. The method of claim 1, wherein the outputting of the on-time baseline comprises outputting an on-time baseline of which a slope is 1, and the actual time according to the progress of the at least one task schedule coincides with the target date to complete the at least one task schedule.

3. The method of claim 1, further comprising:
outputting a current time baseline indicating a current time point.

4. The method of claim 1, wherein the outputting of the project mark related to the at least one task schedule comprises, when the task is completed, marking the project mark with a project mark in a first shape.

5. The method of claim 1, wherein the outputting of the project mark related to the at least one task schedule comprises, when the task is not completed, marking the project mark with a project mark in a second shape.

6. The method of claim 1, wherein the outputting of the project mark related to the at least one task schedule comprises, when the actual time according to the progress of the at least one task schedule is the same as the target date to complete the at least one task schedule, marking the project mark on the on-time baseline.

7. The method of claim 1, wherein the outputting of the project mark related to the at least one task schedule comprises, when the actual time according to the progress of the at least one task schedule is ahead of the target date to complete the at least one task schedule, marking the project mark above the on-time baseline.

8. The method of claim 1, wherein the outputting of the project mark related to the at least one task schedule comprises, when the actual time according to the progress of the at least one task schedule is behind the target date to complete the at least one task schedule, marking the project mark below the on-time baseline.

9. The method of claim 1, further comprising:
providing a Gantt chart.

10. An apparatus for providing a chart for project schedule management, the apparatus comprising:
a user input receiver configured to receive a user input for at least one task schedule from a user;
a processor configured to generate a chart comprising a horizontal axis indicating actual time according to a progress of the at least one task schedule and a vertical axis indicating a target date to complete the at least one task schedule; and
a display configured to output the generated chart on a screen,
wherein the display outputs a project mark related to the at least one task schedule on the chart, and
output an on-time baseline in which the actual time coincides with the target date on the chart.

11. The apparatus of claim 10, wherein the display outputs an on-time baseline of which a slope is 1, and the actual time according to the progress of the at least one task schedule coincides with the target date for completing the at least one task schedule.

12. The apparatus of claim 10, wherein the display outputs a current time baseline indicating a current time point.

13. The apparatus of claim 10, wherein, when the task is completed, the display marks the project mark with a project mark in a first shape.

14. The apparatus of claim 10, wherein, when the task is not completed, the display marks the project mark with a project mark in a second shape.

15. The apparatus of claim 10, wherein the processor is configured to, when the actual time according to the progress of the at least one task schedule is the same as the target date to complete the at least one task schedule, mark the project mark on the on-time baseline through the display.

16. The apparatus of claim 10, wherein the processor is configured to, when the actual time according to the progress of the at least one task schedule is ahead of the target date to complete the at least one task schedule, mark the project mark above the on-time baseline through the display.

17. The apparatus of claim 10, wherein the processor is configured to, when the actual time according to the progress of the at least one task schedule is behind the target date to complete the at least one task schedule, mark the project mark below the on-time baseline through the display.

18. The apparatus of claim 10, wherein the display provides a Gantt chart.

19. A non-transitory computer-readable storage medium storing instructions that, when executed by a processor, cause the processor to perform the method of providing a chart of claim 1.
